(19) United States
(12) Patent Application Publication
(10) Pub. No.: US 2005/0181227 A1
(43) Pub. Date: Aug. 18, 2005

(54) Layer with gradient and method for production thereof

(76) Inventors: Mohammad Djahanbakhsh, Berlin (DE); Tilmann Haug, Weissenhorn (DE); Florian Lampmann, Neu-Ulm (DE)

Correspondence Address: PENDORF & CUTLIFF, 5111 Memorial Highway, Tampa, FL, 33634-7356, US

(21) Appl. No.: 11/057,512

(22) Filed: Feb. 14, 2005

(30) Foreign Application Priority Data
Feb. 12, 2004 (DE) 10 2004 006 857.7

(51) Int. Cl. B22F 3/00; B05D 1/08

(52) U.S. Cl. 428/547; 427/446

(57) ABSTRACT

Hard mechanical coatings applied by thermal spray application onto softer surfaces frequently exhibit insufficient adhesion, so that undesired defoliations occur. It is the task of the present invention to provide a coating with optimal mechanical load bearing capacity and adhesion, as well as a simplified process for production thereof. The task is solved in that a gradient layer is applied by arc wire spraying upon a surface, wherein during the spray application at least one of the process parameters (a) current strength or voltage of the arc or (b) gas pressure of the carrier gas is varied.

### BACKGROUND OF THE INVENTION

1. Field of the Invention

The invention concerns a layer with a gradient according to the precharacterizing portion of Patent Claim 7 and a process for production thereof according to the precharacterizing portion of Patent Claims 1 or 2. This type of layer with gradient and process is generally known from DE 697 02 576 T2 or WO 95 12473 A.

2. Related Art of the Invention

The invention is concerned with thermal spray application, in particular arc wire spraying, of conductive, in particular metallic, coatings upon outer surfaces. This type of coating is employed among other things to increase the mechanical and/or tribological stress bearing ability of the surface, in particular the hardness of the surface. Depending upon the type of coating material and the surface to be coated, the quality of the adhesion may vary, in particular the adhesion tensile strength between the two materials. For example, Cu-based hard coatings on Fe-based surfaces generally exhibit an inadequate adhesion, so that undesired defoliation occurs.

One known solution of this problem comprises applying an adhesion-imparting intermediate layer. Thereby, however, the equipment costs and labor involvement are increased, which can be justified only for a limited number of applications.

According to WO 95 12473 A, a gradient layer with locally varying mechanical characteristics can be produced, in that two different material sprays overlapping each other are simultaneously are sprayed upon surface to be coated, however, with differential changing intensity. This requires a comparatively high cost in equipment.

According to DE 697 02 576 T2 a gradient layer can be produced with locally changing mechanical characteristics by changing the composition of the atomizing gas in its inert and oxidizing components during the thermal spray application.

It is the task of the present invention to provide a coating with optimal mechanical toughness and load bearing capacity and adhesion as well as to provide a simplified process for its production.

With regard to the process for production of a layer with gradient, the invention is disclosed in the characteristics of Patent Claims 1 and 2 and with regard to the gradient layer to be produced is disclosed with reference to the characteristics of Patent Claims 7. The further claims disclose advantageous embodiments and further developments of the inventive process (Patent Claims 3 through 6) and the inventive device (Patent Claim 8).

With regard to the process to be provided, the task is solved in a first inventive embodiment in that a gradient layer is applied onto the surface by thermal application spraying with the aid of a carrier gas, wherein during the spray application the gas pressure is varied.

Many variations of thermal spray application are known to the person of ordinary skill. For example, arc wire spraying, plasma spraying and flame spraying are known. Therein the coating material is molten and transported to the surface to be coated with the aid of a carrier gas.

### SUMMARY OF THE INVENTION

In accordance with the invention, by varying the gas pressure of the carrier gas, in particular in arc wiring spraying, the particle diameter and the transport speed of the molten liquid coating material are varied, whereby a change in the mechanical load bearing capacity, in particular the hardness, and the adhesiveness, in particular the adhesive tensile strength, of the coating, results. An increase in the gas pressure brings about a significant reduction in the particle diameter and its temperature with a simultaneous increase in the transport speed, and this brings about an increase in the mechanical load bearing capacity as well as a reduction in the adhesiveness of the coating. The reverse applies in the case of the reduction of the gas pressure.

With regard to the process to be provided, the task is solved in a second inventive embodiment thereby, that a gradient layer is applied to a surface by arc wire spraying, wherein during the spray application at least one of the process parameters (a) current of the arc or (b) gas pressure of a carrier gas stream is varied.

In accordance with the invention, particle characteristics are varied by variation of the mentioned process parameters, whereby changes in the coating characteristics result. In particular, an increase in the current strength brings about a reduction in the particle temperature and transport speed, wherefrom a reduction in the coating hardness results. The opposite applies in the case of a reduction in the current strength. A minimal value of the current strength is however necessary for maintaining the process.

An increase in the voltage brings about an increase in the particle characteristic temperature, from which an increase in the coating hardness and the adhesive tensile strength as well as a reduction in the flexibility results. The opposite applies in the case of a reduction in voltage.

An increase in gas pressure brings about a reduction of the particle diameter and temperature as well as an increase in the transport speed, from which an increase in the coating hardness and the bending stiffness as well as a reduction in the adhesive tensile strength results. The opposite applies in the case of a reduction of the gas pressure.

The variation of the mentioned process parameters produces no detectable influence on the layer modulus of elasticity and breaking strain.

Preferred ranges of these process parameters lie, with regard to voltage, between 10 V and 100 V, preferably between 20 V and 80 V, in particular between 25 V and 60 V; with regard to current strength, between 50 A and 400 A, preferably between 80 A and 270 A, in particular between 200 A and 250 A and with regard to gas pressure, between 0.1 MPa and 1 MPa, preferably between 0.2 MPa and 0.8 MPa, in particular between 0.25 MPa and 0.7 MPa.

Within these ranges the optimal adjustments can be set for most coating and surface materials, or at least acceptable compromises of the mechanical load bearing capacity and adhesiveness of the coating.

In a further advantageous embodiment of the inventive process, a gas mixture is employed as the carrier gas, and this mixture ratio is varied during spray application.

In a first embodiment a mixture of oxidizing and inert gas, for example oxygen and argon, is employed. By varying the mixture relationship, the oxidation of the coating material is varied and, beyond this, also the mechanical load capacity and adhesiveness.

In a second variant a mixture of oxidizing and oxidizable gas, for example oxygen and methane, is employed. This gas flow serves not only as the carrier gas stream, but rather it is ignited downstream of the arc in the flow direction, whereby a volumetric expansion results, which brings about an acceleration and size reduction of the particles. By varying the mixture relationship, the oxidation of the oxidizable gas and therewith the temperature of the carrier (combustible) gas and the therein transportable particles is varied. From this there results a variation of the mechanical load capacity and adhesiveness. A higher proportion of oxidizable material necessitates a higher gas and particle temperature, whereby hardness, adhesiveness and adhesive tensile strength are likewise increased. The opposite applies in the case of a reduction of the proportion of oxidizable gas.

The variations of the mixture ratio can occur additively or alternative to the variations of the other mentioned process parameters. The described changes of the particle and coating characteristics become particularly pronounced in the case of use of a carrier combustible gas; they do occur, however, in the case of use of a non-combustible carrier gas and appropriate parameter variations.

With regard to the gradient layer to be produced, the invention is embodied by a metallic gradient layer on a surface which layer exhibits a gradient with respect to the size of the microstructures of the layer.

A particularly suited gradient layer exhibits, in the direction of the surface to be coated, significantly larger microstructures—preferably with an average structure diameter of 50-100 μm—than in the direction of its outward facing surface, where the microstructures have an average diameter size of preferably 10-50 μm. From a structure size gradient of this type there results a coating which has a good adhesion to the substrate and simultaneously a good mechanical load carrying capacity, in particular hardness, toward the outside, without there being any need for substantial change in the chemical composition of the coating.

This type of gradient layer is particularly advantageously employed on mechanically strongly stressed surfaces, preferably on the inner surfaces of a cylindrical surface, for example a cylinder bore or a large end bearing.

For most applications layer thicknesses of the gradient layer of between 50 and 1000 μm are preferred, in certain cases however thinner or thicker layers may be of advantage.

In the following the inventive process and the therewith produced gradient layer are described in greater detail on the basis of an illustrative embodiment:

According to the illustrative embodiment a bronze-gradient layer (CuSn₆Ag) is spray-applied on a FE-based surface (for example forged steel C70MnVS4). The spray application occurs using an arc wire burner, wherein a mixture of methane and oxygen is used as the carrier combustible gas with a mixture relationship of 0.86, which ignites following the arc. The current of the arc is 200 A. The substrate surface is 160 mn from the arc wire burner. During the spray application the process parameters are varied, namely, the voltage of the arc and teh gas pressure of the carrier gas stream. At the beginning, the voltage is 50 V with a gas pressure of 0.28 MPa. Both parameters are continuously varied over a spray application time of 20 seconds transitioning to end values 30 V and 0.62 MPa. By these changes of the process parameters, the particle characteristics temperature, transport speed and diameter of the particle characteristics change from average starting values of approximately 1900° C.; 80 m/s; 3.5 to average end values of approximately 1650° C.; 120 m/s; 3.2. (The particle diameter is provided in a relative unit, which is derived from the average minimal diameter of the particles in the pixels of a CCD-camera image.)

With this process a gradient layer of approximately 250-350 μm thickness is produced, which near to the substrate has a microstructure with an average size of 50-100 μm and in the vicinity of its outward facing surface has an average size of 10-50 μm. From this, there results a good adhesion to the substrate and a good mechanical load bearing capacity facing the outside. The layer characteristics near the substrate are: hardness 170 vickers 0.1/bend stiffness: 450 MPa/adhesion tensile strength: 45 MPa; and in the vicinity of the surface: hardness: 200 vickers 0.1/bend stiffness: 550 MPa/adhesive tensile strength: 25 MPa. The chemical composition remains essentially unchanged.

The inventive process has demonstrated itself in the preceding illustrated embodiment as particularly suited for the thermal spray application of a gradient layer upon mechanically strongly stressed surfaces, such as, for example, cylinder bores or large end bearings of internal combustion engines—above all in the automobile industry.

In particular, a substantial improvement in the adhesiveness with the simultaneous increase in the mechanical load bearing capacity can be achieved.

The invention is not limited to the above described illustrated embodiment but rather is broadly applicable.

1. Process for thermal spray application of a gradient layer upon a surface with the aid of a carrier gas, thereby characterized, that during the spray application the gas pressure is varied.

2. Process for thermal spray application of a gradient layer upon a surface using arc wire spray application, thereby characterized, that during the spray application at least one of the process parameters (a) current or voltage of the arc or (b) gas pressure of the carrier gas is varied.

3. Process according to claim 2, thereby characterized, that the voltage is varied between 10 V and 100 V, preferably between 20 V and 80 V, in particular between 25 V and 60 V.

4. Process according to claim 2 or 3, thereby characterized, that the current strength is varied between 150 A and 400 A, preferably between 180 A and 270 A, in particular between 200 A and 250 A.

5. Process according to one of claims 1 through 4, thereby characterized, that the gas pressure is varied between 0.1 MPa and 1 MPa, preferably between 0.2 MPa and 0.8 MPa, in particular between 0.25 MPa and 0.7 MPa.

6. Process according to one of claims 1 through 5, thereby characterized, that as the carrier gas a gas mixture is employed, of which the mixture relationship is varied during spray application.

7. Metallic gradient layer on a surface characterized thereby, that a gradient exits with regard to the size of the microstructures of the layer.

8. Gradient layer according to claim 7, thereby characterized, that it is located on the inner wall of a cylinder surface, in particular a cylinder bore of a motor or connecting rod or piston rod.
